(19) United States
(12) Patent Application Publication
(10) Pub. No.: US 2020/0247562 A1
(43) Pub. Date: Aug. 6, 2020

(54) INTEGRATED RF POWERED PLATFORM FOR STRUCTURE HEALTH MONITORING (SHM) OF AIRCRAFT USING NANOSTRUCTURED SENSING MATERIAL

(71) Applicant: Analog Devices, Inc., Norwood, MA (US)

(72) Inventor: Yosef Stein, Sharon, MA (US)

(73) Assignee: Analog Devices, Inc., Norwood, MA (US)

(21) Appl. No.: 16/268,437

(22) Filed: Feb. 5, 2019

(51) Int. Cl. B64F 5/60; H01Q 1/36; H01Q 1/28; G01N 17/04; G01N 17/02; B64D 45/00; G01M 5/00

(52) U.S. Cl. CPC B64F 5/60; H01Q 1/368; H01Q 1/286; B82Y 15/00; G01N 17/02; B64D 45/00; G01M 5/0033; G01N 17/04

(57) ABSTRACT

Aircraft sensors are described which record a condition of interest of the aircraft during flight without being powered. The sensor may include a sensing element comprising a nanostructure material which permanently changes state in connection with a permanent change in state of the aircraft, thus recording the condition of the aircraft. When the aircraft is on the ground, the recorded condition is read from the sensor using a wireless radio frequency (RF) reader, rather than communicating the recorded state during flight. In this manner, the sensor operates without interfering with the aircraft while in flight.

### FIELD OF THE DISCLOSURE

The present application relates to sensors for aircraft.

### BACKGROUND

Aircraft sensors typically operate during flight of the aircraft. They sense the condition of interest and communicate in a wired or wireless fashion with other components of the aircraft.

### SUMMARY OF THE DISCLOSURE

Aircraft sensors are described which record a condition of interest of the aircraft during flight without being powered. The sensor may include a sensing element comprising a nanostructure material which permanently changes state in connection with a permanent change in state of the aircraft, thus recording the condition of the aircraft. When the aircraft is on the ground, the recorded condition is read from the sensor using a wireless radio frequency (RF) reader, rather than communicating the recorded state during flight. In this manner, the sensor operates without interfering with the aircraft while in flight.

According to an aspect of the present application, a method of operating a passive nanostructure sensor to sense a condition of an aircraft without radio frequency (RF) interference during flight, the method comprises: during flight, recording the condition of the aircraft by permanently changing a state of a nanostructure sensing element of the nanostructure sensor without being powered and without transmitting data on the condition during the flight; and subsequent to flight, transmitting the data on the condition via a wireless data link in response to receiving an activation signal via the wireless data link.

According to an aspect of the present application, a passive aircraft sensor node comprises: a multi-layer stack including: a first layer having a nanostructure sensing element configured to contact a structure and record a condition of the structure by permanently changing a state of the nanostructure sensing element in response to a permanent change in condition of the structure without being powered; a second layer comprising a microelectronics circuit; and a third layer comprising a far field energy harvesting antenna, the second layer being between the first and third layers.

According to an aspect of the present application, a passive nanostructure sensor patch for sensing a condition of an aircraft, comprising: a first layer having a nanostructure sensing element configured to conform to the aircraft and change state permanently in response to a permanent change in state of the aircraft while unpowered; a second layer coupled to the first layer and comprising a microelectronics circuit; and a third layer comprising an antenna configured to operate in response to activation by a reader device when the aircraft is not in flight, wherein the first and third layers are coupled to opposite sides of the second layer.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in all the figures in which they appear.

FIG. 1A is a perspective view of an aircraft with a plurality of sensors of the types described herein, according to a non-limiting embodiment of the present application.

FIG. 1B is a bottom view of the aircraft of FIG. 1A with a sensor of the types described herein.

FIG. 2A is an exploded view of an aircraft sensor, according to a non-limiting embodiment of the present application.

FIG. 2B illustrates the sensor of FIG. 2A in constructed form, demonstrating the conformable nature of the sensor.

FIG. 3 is a block diagram illustrating an example of the components of an aircraft sensor according to a non-limiting embodiment.

FIG. 4 illustrates a reading operation of an aircraft sensor of the types described herein, according to a non-limiting embodiment.

FIG. 5 is a flowchart of a method of operating an aircraft sensor of the types described herein.

FIG. 6 illustrates an embodiment of the present application in which a nanostructure sensor is configured to sense a condition of a stored sensitive material.

### DETAILED DESCRIPTION

Aspects of the present application provide aircraft sensors. The aircraft sensors may comprise a smart sensing material, such as a nanostructure sensing material, that can record a condition of interest of the aircraft even when unpowered. For example, the nanostructure sensing element may comprise a carbon nanotube (CNT) layer embedded in a polymer matrix which contacts and conforms to the aircraft, and which permanently changes state to mimic a change in state of the aircraft. As one example, the sensing element may include a CNT corrosion sensor or crack sensor, which corrodes or cracks if the aircraft surface to which the sensor is attached corrodes or cracks. In this manner, the condition of the aircraft may be recorded without the sensor being powered. Moreover, because the aircraft condition may be recorded via a permanent change in state of the sensor, the sensor effectively stores the information for reading at a later time, such as when the aircraft is on the ground. In this manner, the sensor may beneficially record the aircraft condition during flight without power, but not interfere with the aircraft in any manner during flight since the data need not be read out during flight.

According to an aspect of the present application, a method of sensing a condition of an aircraft is provided. The method comprises recording a condition of the aircraft during flight using a sensor adhered to the aircraft, but without powering the sensor. The sensor may include a nanostructure sensing element which records the condition of the aircraft by permanently changing state in response to a permanent change in state of the aircraft. Subsequent to flight, the recorded condition is read from the sensor using a wireless reader device. The wireless reader device may transmit a wireless activation signal to the sensor, prompting the sensor to transmit back to the reader the recorded condition.

According to an aspect of the present application, a sensor having a nanostructure sensing element may be used to monitor a condition of an object over an extended period of time, without power. The object may be an ammunition casing, housing for sensitive and/or dangerous material, such as a container for nuclear material, or other material or structure for which long term structural health monitoring may be desirable. The sensor may be adhered to the structure of interest, and may permanently change state if and when the structure permanently changes state. In this manner, the sensor may record the condition of interest without being powered, and without needing to transmit or receive signals. At a desired time, a reader device may be used to read the recorded condition from the sensor.

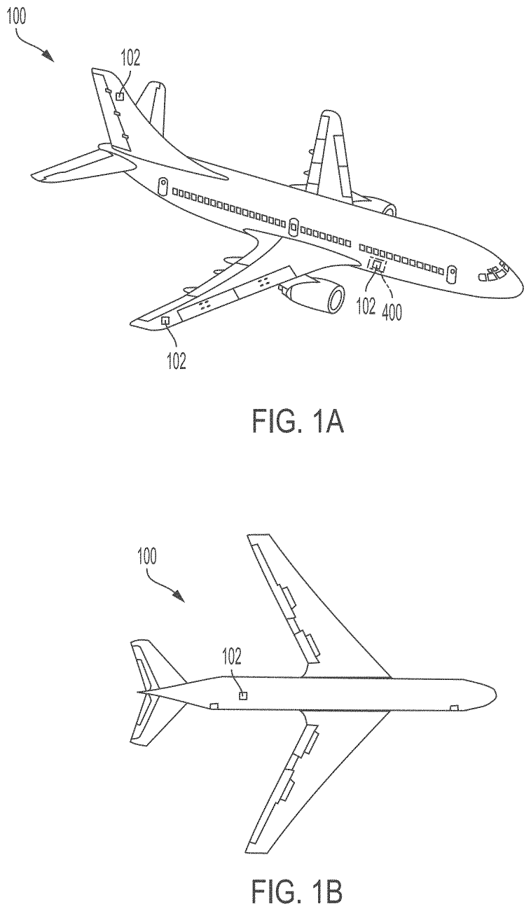

FIGS. 1A and 1B illustrate an aircraft sensing configuration according to a non-limiting aspect of the present application. The sensing system includes an aircraft 100 and a plurality of sensors 102. FIG. 1A is a perspective view. FIG. 1B is a bottom view of the aircraft.

The illustrated aircraft 100 is an airplane in this non-limiting embodiment. However, other aircraft may use sensing systems of the types described herein, for structural health monitoring of the aircraft. For example, rockets, space shuttles, drones, gliders, satellites, or other aircraft may make use of the sensors and sensing techniques described herein. Thus, the nature of the aircraft is not limiting.

The sensors 102 may be nanostructure sensors. They may comprise smart sensing materials, such as a nanostructure sensing layer. The nanostructure sensing layer may include a nanostructure material such as carbon nanotubes (CNT). In some embodiments, the nanostructure sensing element may include CNTs embedded in a polymer matrix. The smart sensing material may change in response to a change in condition of the sensed structure, such as the aircraft.

The sensors 102 may sense conditions which represent a permanent change in state of the aircraft. For example, the sensors 102 may be corrosion sensors, configured to sense a state of corrosion of the aircraft. The sensors 102 may be fatigue crack sensors, configured to sense cracking of the aircraft. The aircraft 100 may have multiple types of sensors, such as corrosion sensors and fatigue crack sensors, or other sensors which may operate by experiencing a permanent change in state to mimic a change in state of the monitored aircraft.

The aircraft 100 may include any suitable number of sensors 102. In some embodiments, one or more sensors 102 may be included.

The sensors 102 may be placed at suitable locations of the aircraft. In some embodiments, the sensors 102 may be positioned on the airframe. The sensors may be placed on the wings, tail, nose, windows, fuselage, or other portions of the aircraft. As shown in FIGS. 1A and 1B, the sensors 102 may be placed on the topside or underside of the aircraft.

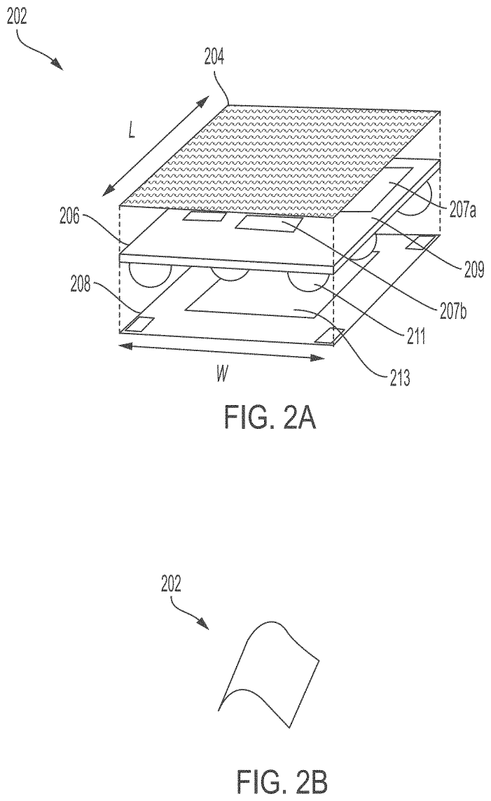

The sensors 102 may take various suitable forms. In some embodiments, a sensor for sensing a condition of aircraft may be a multi-layer sensor. FIG. 2A illustrates a non-limiting example. One or more sensors 102 of FIG. 1 may have the construction of sensor 202 of FIG. 2A, although other sensor structures are possible.

The sensor 202 of FIG. 2A is a multi-layer sensor comprising three layers. The sensor 202 includes a first layer 204 having a nanostructure sensing element, a second layer 206 having a microelectronics circuit, and a third layer 208 comprising an antenna. Each is described further below.

The first layer 204 is a sensing layer. In at least some embodiments, the sensing layer comprises a nanostructure sensing element. In some embodiments, the nanostructure sensing element comprises CNTs. In some such embodiments, the nanostructure sensing element comprises CNTs embedded in a polymer matrix. The nanostructure sensing element is configured to contact the aircraft, for example being adhered to a surface of the aircraft. The nanostructure sensing element is configured to record the condition of interest of the aircraft. For example, if the condition of interest is corrosion, the nanostructure sensing element may be a corrosion sensing element, configured to contact the aircraft and corrode as the aircraft corrodes. In this manner, the nanostructure sensing element records the state of corrosion even when unpowered. In some embodiments, the nanostructure sensing element may be a fatigue cracking sensing element, configured to contact the aircraft and crack if the aircraft cracks. In this manner, the nanostructure sensing element records the state of fatigue cracking even when unpowered. Corrosion and fatigue cracking sensing elements are two non-limiting embodiments of nanostructure sensing elements configured to monitor a permanent change in condition of the aircraft even when unpowered. Other types of sensing elements may be used.

The second layer 206 is a microelectronics circuit layer comprising a microelectronics circuit. The microelectronics circuit may include suitable circuit components 207a and 207b for communicating with the nanostructure sensing element the antenna of the third layer, as described further below. In some embodiments, the microelectronics circuit comprises digital circuitry, such as an analog-to-digital converter, a digital core, and transceiver circuitry. In some embodiments, the microelectronics circuit is a mixed analog-digital microelectronics circuit. The circuit may include discrete circuit components formed on a printed circuit board (PCB) 209. In an alternative embodiment, the microelectronics circuit may include an integrated circuit (IC), such as an application specific integrated circuit (ASIC). The second layer 206 may include connectors 211 for mechanically and/or electrically interconnecting the second layer 206 and the third layer 208. For example, the connectors 211 may be solder bumps or balls, or conductive traces in some embodiments.

The third layer 208 comprises an antenna 213. Thus, the third layer 208 may be considered an antenna layer. The antenna 213 may be a far field antenna. The antenna 208 may perform multiple functions. One function may be energy harvesting. The antenna 213 may harvest radiofrequency (RF) energy. The harvested RF energy may be used to power the microelectronics circuit of the second layer 206. The antenna 213 may communicate data signals. In some embodiments, the antenna 213 receives wireless signals, such as control signals from a reader device, as described further below. The antenna 213 may transmit data signals representing the recorded condition from the nanostructure sensing element. In the illustrated embodiments, the antenna is a patch antenna. Alternatives are possible, however.

The sensor 202 may have any suitable dimensions. The sensor 202 may have a length L and width W. Both the length and width may be between a few millimeters and a few inches. The sensor 202 may have a thickness between tens of microns and tens of millimeters, as non-limiting examples.

The sensor 202 may be a passive sensor, meaning that it may lack a battery or local power source. In some embodiments, the sensor 202 is configured to harvest energy, such as RF energy using the antenna 213.

In at least some embodiments, the sensor 202 may be flexible, such that it can conform to the aircraft. FIG. 2B illustrates the flexible nature of the sensor 202. In some embodiments, each layer of the sensor 202 may be flexible. As such, the sensor may conform to curved portions of the aircraft airframe, such as the wing, tail, or nose and may sense conditions of the aircraft airframe. That said, in some embodiments the sensor may not be flexible and may be adhered to the aircraft in any suitable manner.

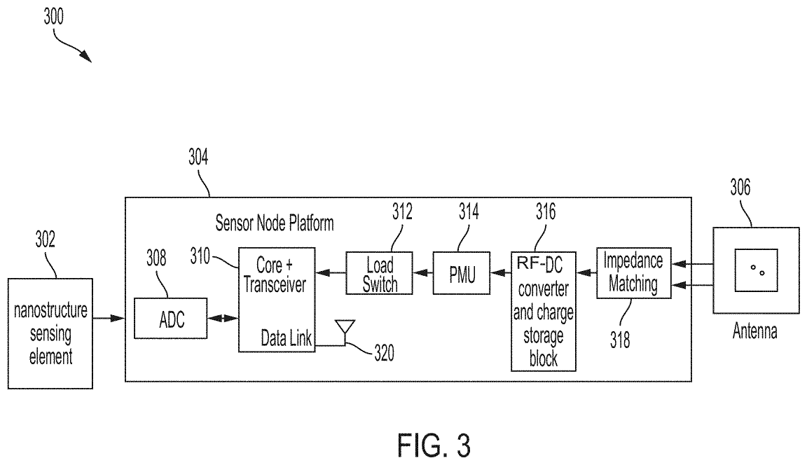

FIG. 3 is a block diagram illustrating an example of the components of an aircraft sensor according to a non-limiting embodiment. The sensor 300 includes a nanostructure sensing element 302, a microelectronics circuit 304 and an antenna 306.

The nanostructure sensing element 302 may be any of the types of nanostructure sensing elements described herein previously. For example, the nanostructure sensing element may be a corrosion sensing element or a crack fatigue sensing element. The nanostructure sensing element 302 may comprise a smart material, such as a layer of CNTs embedded in a polymer matrix.

The microelectronics circuit 304 includes several components in this non-limiting example. An analog-to-digital converter (ADC) 308, combined core and transceiver 310, load switch 312, power management unit (PMU) 314, radio frequency (RF) to direct current (DC) energy harvester and charge storage block 316, impedance matching component 318, and antenna 320 are included in the microelectronics circuit 304.

The microelectronics circuit 304 may operate to read a state of the nanostructure sensing element 302 when activated by an activation signal received from the antenna 320, which may represent a low energy Bluetooth data link, as a non-limiting example. The sensor 300. The ADC 308 may receive an analog signal from the nanostructure sensing element 302 and convert it to a digital signal. Thus, the ADC 308 may generate a digital representation of the measured signal of the condition recorded by the nanostructure sensing element 302. The core 310 may process the digital signal in any suitable manner. The core 310 may also trigger reading of the condition of the nanostructure sensing element 302 in response to receiving an activation signal from the antenna 320. Otherwise, the microelectronic circuit 304 may be dormant, with the nanostructure sensing element 302 recording the condition of the aircraft even when unpowered.

The sensor 300 may be passive. In some embodiments, the sensor 300 may lack a battery or local power source, and may harvest RF energy to power its operations in some embodiments. The antenna 306 may receive an RF signal. The impedance matching circuit 318 may perform an impedance matching function. The received RF signal may be converted to a DC signal and stored in RF-DC and charge storage block 316. The DC signal may be provided to the PMU 314, and then to the load switch 312, which may be switched ON and OFF depending on the state of operation of the sensor 300 in terms of whether it is active (e.g., when the aircraft is not in flight) or inactive (when the aircraft is in flight).

The antenna 306 may be an RF far field energy harvesting antenna. In some embodiments, the antenna 306 is a patch antenna. The antenna 306 may be a flexible patch antenna in some embodiments.

It should be appreciated from the illustrated embodiment of FIG. 3 that in some embodiments a sensor of the types described herein may include multiple antennae. One may function as an energy harvesting antenna. Another may operate as part of a data link to receive and transmit data signals. Furthermore, in some embodiments the two antennae may operate in different ISM bands. For example, the antenna 306 may operate in a first ISM band and the antenna 320 may operate in a second ISM band. Alternatively, in some embodiments, the two antennae may operate in the same ISM band.

It should be noted that the microelectronics circuit 304 may lack a memory, or at least that in some embodiments the any memory included is not used to log data during flight. The nature of the nanostructure sensing element 302 may allow for it to record the condition of interest of the monitored structure without logging any data to memory. Rather, the condition is recorded in the state of the sensing material in at least some embodiments.

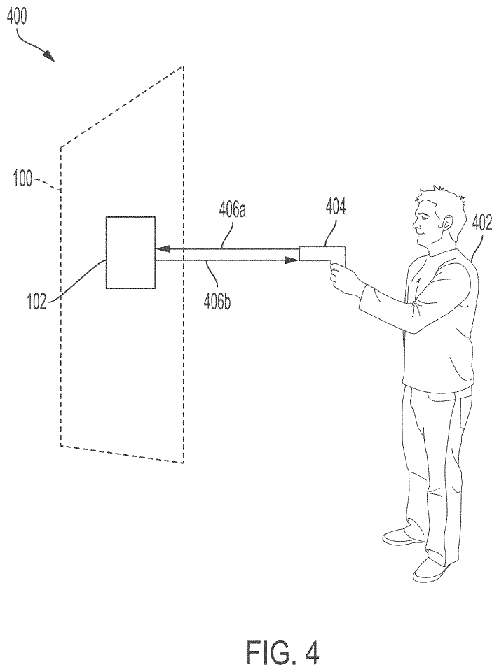

As described previously herein, embodiments of the present application provide sensors for aircraft which record a condition of the aircraft during flight but which do not transit or receive signals during flight. In this manner, the sensor may operate to record the aircraft condition without interfering with flight in any manner. In some embodiments, the sensor may be read when the aircraft is not in flight, using a suitable reader device. FIG. 4 illustrates a non-limiting example.

FIG. 4 illustrates a reading operation of an aircraft sensor of the types described herein, according to a non-limiting embodiment. The FIG. 4 illustrates the portion 400 of the aircraft 100 shown in FIG. 1, together with an operator 402 operating a reader device 404 (or “reader” for short). The reader device 404 may be an RF reader, and may be configured as a hand-held device. The reader device 404 may emit RF signals 406a and receive RF signals 406b.

According to a non-limiting manner of operation, the operator 402 may read the recorded condition from the nanostructure sensing element of sensor 102 when the aircraft is not in flight. The operator 402 may bring the reader device 404 close to the sensor 102 and depress a button, causing the reader device 404 to emit an RF signal 406a. In some embodiments, the RF signal 406a may be an activation signal. The activation signal may be received by the sensor 102, for example by a transceiver of the sensor 102, and cause the sensor 102 to read the condition of the nanostructure sensing element. The sensor 102 may then transmit RF signal 406b via an antenna of the sensor 102 (e.g., via an antenna like antenna 320) to the reader device 404. The RF signal 406b may be a data signal including data representing the condition recorded by the nanostructure sensing element of sensor 102. In this manner, the condition recorded by the sensor 102 may be read without interfering with flight. Depending on the data read from the sensor 102, some type of action may be taken by the operator 402. For example, if the read condition indicates maintenance to the aircraft is desirable, the operator 402 may schedule such maintenance.

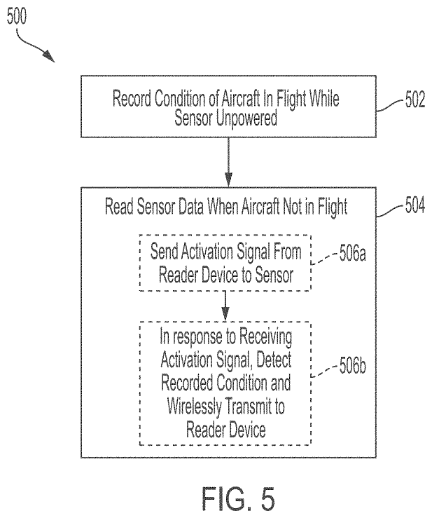

FIG. 5 is a flowchart of a method of operating an aircraft sensor of the types described herein, and may be applied in the configuration of FIG. 4. The method 500 begins at act 502, with recording the condition of the aircraft in flight while the sensor is unpowered. The sensor may be any of the types described previously herein. For example, the sensor may be a corrosion sensor and act 502 may comprise recording a state of corrosion of the aircraft while in flight. The sensor may be a fatigue crack sensor and act 502 may comprise recording fatigue cracking of the aircraft while in flight.

The method 500 proceeds to act 504, at which the recorded sensor data may be read when the aircraft is not in flight. This may involve, at act 506a, sending an activation signal from a reader device—such as reader device 404—to the sensor, and likewise receiving at the sensor the activation signal. Act 504 may also comprise act 506b, at which, in response to receiving the activation signal, the sensor may detect the recorded condition and wirelessly transmit data representing the recorded condition to the reader device.

The method 500 may be performed any suitable number of times, and may be performed on more than one sensor.

As described, aspects of the present application provide aircraft sensors. However, not all embodiments are limited to sensors for aircraft. For example, sensors of the types described herein may be used in other contexts as well. According to an aspect of the present application, a sensor having a nanostructure sensing element may be used to monitor a condition of an object over an extended period of time, without power. The object may be an ammunition casing, housing for sensitive and/or dangerous material, such as a container for nuclear material, or other material or structure for which long term condition monitoring may be desirable. The sensor may be adhered to the structure of interest, and may permanently change state if and when the structure permanently changes state. In this manner, the sensor may record the condition of interest without being powered, and without needing to transmit or receive signals. At a desired time, a reader device may be used to read the recorded condition from the sensor.

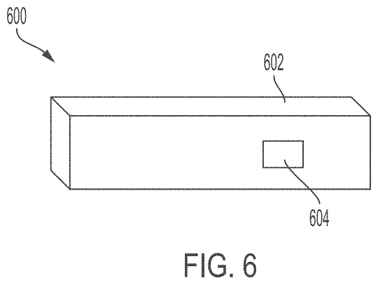

FIG. 6 illustrates a non-limiting example. The system 600 includes a structure 602 for which it is desired to monitor a condition of interest. The system 600 also includes a sensor 604, being any of the types described herein. The structure 602 may me a container of nuclear material, may be a rocket, missile, or other form of weapon. The structure 602 may be stored in a location for an extended period, such as a secure storage facility. Monitoring the condition of the structure 602 may be desirable to know whether the structure remains viable for use, or whether repairs or replacement are needed. The sensor may be read in the manner previously described in connection with FIG. 4. For example, an operator may periodically read the sensor 604 with a reader device. For instance, the sensor may be read every few months or years to monitor the condition of the structure, thus allowing a determination as to whether the structure remains viable.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

What is claimed is:

1. A method of operating a passive nanostructure sensor to sense a condition of an aircraft without radio frequency (RF) interference during flight, the method comprising:
during flight, recording the condition of the aircraft by permanently changing a state of a nanostructure sensing element of the nanostructure sensor without being powered and without transmitting data on the condition during the flight; and
subsequent to flight, transmitting the data on the condition via a wireless data link in response to receiving an activation signal via the wireless data link.

2. The method of claim 1, wherein the passive nanostructure sensor comprises a far field antenna, and wherein the method further comprises harvesting RF energy via the far field antenna in a first ISM band, and wherein transmitting the data on the condition comprises transmitting the data on the condition in a second ISM band.

3. The method of claim 1, wherein the passive nanostructure sensor comprises a far field antenna, and wherein the method further comprises harvesting RF energy via the far field antenna in a first ISM band, and wherein transmitting the data on the condition comprises transmitting the data on the condition in the first ISM band.

4. The method of claim 1, wherein sensing the condition of the aircraft is performed without logging the data on the condition to memory of the nanostructure sensor.

5. The method of claim 1, wherein sensing the condition of the aircraft comprises sensing a state of corrosion of the aircraft.

6. The method of claim 1, wherein sensing the condition of the aircraft comprises sensing a state of fatigue cracks of the aircraft.

7. A passive aircraft sensor node, comprising:
a multi-layer stack including:
a first layer having a nanostructure sensing element configured to contact a structure and record a condition of the structure by permanently changing a state of the nanostructure sensing element in response to a permanent change in condition of the structure without being powered;
a second layer comprising a microelectronics circuit; and
a third layer comprising a far field energy harvesting antenna, the second layer being between the first and third layers.

8. The passive sensor node of claim 7, wherein the microelectronics circuit and far field energy harvesting antenna are configured to be disabled.

9. The passive aircraft sensor node of claim 7, wherein the nanostructure sensing element is a carbon nanotube (CNT) sensor.

10. The passive aircraft sensor node of claim 7, wherein the multi-layer stack is configured to be activated to read a state of the nanostructure sensing element and transmit data from the far field antenna in response to receiving an activation signal via the far field antenna.

11. A passive nanostructure sensor patch for sensing a condition of an aircraft, comprising:
a first layer having a nanostructure sensing element configured to conform to the aircraft and change state permanently in response to a permanent change in state of the aircraft while unpowered;
a second layer coupled to the first layer and comprising a microelectronics circuit; and
a third layer comprising an antenna configured to operate in response to activation by a reader device when the aircraft is not in flight, wherein the first and third layers are coupled to opposite sides of the second layer.

12. The passive nanostructure sensor patch for sensing a condition of an aircraft of claim 11, wherein the nanostructure sensing element comprises carbon nanotubes (CNTs) embedded in a structural nanocomposite polymer matrix.

13. The passive nanostructure sensor patch for sensing a condition of an aircraft of claim 11, wherein the microelectronics circuit lacks a memory.

14. The passive nanostructure sensor patch for sensing a condition of an aircraft of claim 11, wherein the microelectronics circuit has a memory, and wherein the nanostructure sensing element is coupled to the memory only in response to the antenna receiving an activation signal from a reader device.

15. The passive nanostructure sensor patch for sensing a condition of an aircraft of claim 11, wherein the microelectronics circuit comprise digital circuitry including a digital core.

16. The passive nanostructure sensor patch for sensing a condition of an aircraft of claim 11, wherein the first, second, and third layers are laminated in a conformable multi-layer stack.

17. The passive nanostructure sensor patch for sensing a condition of an aircraft of claim 11, wherein the microelectronics circuit is configured to operate the antenna in an ISM band.

18. The passive nanostructure sensor patch for sending a condition of an aircraft of claim 17, wherein the antenna is an energy harvesting antenna and wireless data link antenna.

19. The passive nanostructure sensor patch for sensing a condition of an aircraft of claim 11, wherein the antenna comprises an energy harvesting antenna and a wireless data link antenna, and wherein the microelectronics circuit is configured to operate the energy harvesting and wireless data link antennas in different ISM bands.

20. The passive nanostructure sensor patch for sensing a condition of an aircraft of claim 11, wherein the antenna comprises an energy harvesting antenna and a wireless data link antenna, and wherein the microelectronics circuit is configured to operate the energy harvesting and wireless data link antennas in the same ISM band.
